(19) United States
(12) Patent Application Publication
(10) Pub. No.: US 2015/0100702 A1
(43) Pub. Date: Apr. 9, 2015

(54) SWITCHING BETWEEN ADAPTATION SETS DURING MEDIA STREAMING

(71) Applicant: QUALCOMM Incorporated, San Diego, CA (US)

(72) Inventors: Arvind S. Krishna, San Diego, CA (US); Lorenz C. Minder, Evanston, IL (US); Deviprasad Putchala, San Diego, CA (US); Fatih Ulupinar, San Diego, CA (US)

(73) Assignee: QUALCOMM Incorporated, San Diego, CA (US)

(21) Appl. No.: 14/048,210

(22) Filed: Oct. 8, 2013

(51) Int. Cl. H04L 29/06

(52) U.S. Cl. CPC H04L 65/601; H04L 65/4069
USPC 709/231

(57) ABSTRACT

A device for retrieving media data includes one or more processors configured to retrieve media data from a first adaptation set including media data of a first type, present media data from the first adaptation set, in response to a request to switch to a second adaptation set including media data of the first type: retrieve media data from the second adaptation set including a switch point of the second adaptation set, and present media data from the second adaptation set after an actual playout time has met or exceeded a playout time for the switch point.

### TECHNICAL FIELD

This disclosure relates to storage and transport of encoded multimedia data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4. Part 10, Advanced Video Coding (AVC), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as the MP4 file format and the advanced video coding (AVC) file format. Such packetized video data may be transported in a variety of ways, such as transmission over a computer network using network streaming.

### SUMMARY

In general, this disclosure describes techniques related to switching between adaptation sets during streaming of media data, e.g., over a network. In general, an adaptation set may include media data of a particular type, e.g., video, audio, timed text, or the like. Although conventionally, in media streaming over a network, techniques have been provided for switching between representations within an adaptation set, the techniques of this disclosure are generally directed to switching between adaptation sets themselves.

In one example, a method of retrieving media data includes retrieving media data from a first adaptation set including media data of a first type, presenting media data from the first adaptation set, in response to a request to switch to a second adaptation set including media data of the first type: retrieving media data from the second adaptation set including a switch point of the second adaptation set, and presenting media data from the second adaptation set after an actual playout time has met or exceeded a playout time for the switch point.

In another example, a device for retrieving media data includes one or more processors configured to retrieve media data from a first adaptation set including media data of a first type, present media data from the first adaptation set, in response to a request to switch to a second adaptation set including media data of the first type: retrieve media data from the second adaptation set including a switch point of the second adaptation set, and present media data from the second adaptation set after an actual playout time has met or exceeded a playout time for the switch point.

In another example, a device for retrieving media data includes means for retrieving media data from a first adaptation set including media data of a first type, means for presenting media data from the first adaptation set, means for retrieving, in response to a request to switch to a second adaptation set including media data of the first type, media data from the second adaptation set including a switch point of the second adaptation set, and means for presenting, in response to the request, media data from the second adaptation set after an actual playout time has met or exceeded a playout time for the switch point.

In another example, a computer-readable storage medium has stored thereon instructions that, when executed, cause a processor to retrieve media data from a first adaptation set including media data of a first type, present media data from the first adaptation set, in response to a request to switch to a second adaptation set including media data of the first type, retrieve media data from the second adaptation set including a switch point of the second adaptation set; and present media data from the second adaptation set after an actual playout time has met or exceeded a playout time for the switch point.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a conceptual diagram illustrating elements of example multimedia content.

FIG. 3 is a block diagram illustrating elements of an example video file, which may correspond to a segment of a representation of multimedia content.

FIGS. 4A and 4B are flowcharts illustrating an example method for switching between adaptation sets during playback in accordance with the techniques of this disclosure.

FIG. 5 is a flowchart illustrating another example method for switching between adaptation sets in accordance with the techniques of this disclosure.

### DETAILED DESCRIPTION

In general, this disclosure describes techniques related to streaming of multimedia data, such as audio and video data, over a network. The techniques of this disclosure may be used in conjunction with dynamic adaptive streaming over HTTP (DASH). This disclosure describes various techniques that may be performed in conjunction with network streaming, any or all of which may be implemented alone or in any combination. As described in greater detail below, various devices performing network streaming may be configured to implement the techniques of this disclosure.

In accordance with DASH and similar techniques for streaming data over a network, multimedia content (such as a movie or other media content, which may also include audio data, video data, text overlays, or other data, referred to collectively as “media data”) may be encoded in a variety of ways and with a variety of characteristics. A content preparation device may form multiple representations of the same multimedia content. Each representation may correspond to a particular set of characteristics, such as coding and rendering characteristics, to provide data usable by a variety of different client devices with various coding and rendering capabilities. Moreover, representations having various bitrates may allow for bandwidth adaptation. That is, a client device may determine an amount of bandwidth that is currently available and select a representation based on the amount of available bandwidth, along with coding and rendering capabilities of the client device.

In some examples, a content preparation device may indicate that a set of representations has a set of common characteristics. The content preparation device may then indicate that the representations in the set form an adaptation set, such that representations in the set can be used for bandwidth adaptation. That is, representations in the adaptation set may differ from each other in bitrate, but otherwise share substantially the same characteristics (e.g., coding and rendering characteristics). In this manner, a client device may determine common characteristics for various adaptation sets of multimedia content, and select an adaptation set based on coding and rendering capabilities of the client device. Then, the client device may adaptively switch between representations in the selected adaptation set based on bandwidth availability.

In some cases, adaptation sets may be constructed for particular types of included content. For example, adaptation sets for video data may be formed such that there is at least one adaptation set for each camera angle, or camera perspective, of a scene. As another example, adaptation sets for audio data and/or timed text (e.g., subtitle text data) may be provided for different languages. That is, there may be an audio adaptation set and/or a timed text adaptation set for each desired language. This may allow a client device to select an appropriate adaptation set based on user preferences, e.g., language preference for audio and/or video. As another example, a client device may select one or more camera angles based on user preference. For example, a user may wish to view an alternate camera angle of a particular scene. As another example, a user may wish to view relatively more or less depth in a three-dimensional (3D) video, in which case the user may select two or more views having relatively closer or more distant camera perspectives.

Data for the representations may be separated into individual files, typically referred to as segments. Each of the files may be addressable by a particular uniform resource locator (URL). A client device may submit a GET request for a file at a particular URL to retrieve the file. In accordance with the techniques of this disclosure, the client device may modify the GET request by including an indication of a desired byte range within the URL path itself, e.g., according to a URL template provided by a corresponding server device.

Video files, such as segments of representations of media content, may conform to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

The ISO Base Media File Format is designed to contain timed media information for a presentation in a flexible, extensible format that facilitates interchange, management, editing, and presentation of the media. ISO Base Media File format (ISO/IEC 14496-12:2004) is specified in MPEG-4 Part-12, which defines a general structure for time-based media files. The ISO Base Media File format is used as the basis for other file formats in the family such as AVC file format (ISO/IEC 14496-15) defined support for H.264/MPEG-4 AVC video compression, 3GPP file format, SVC file format, and MVC file format. 3GPP file format and MVC file format are extensions of the AVC file format. ISO base media file format contains the timing, structure, and media information for timed sequences of media data, such as audio-visual presentations. The file structure may be object-oriented. A file may be simply decomposed into basic objects and the structure of the objects may be implied from their type.

Files conforming to the ISO base media file format (and extensions thereof) may be formed as a series of objects, called “boxes.” Data in the ISO base media file format may be contained in boxes, such that no other data needs to be contained within the file and there need not be data outside of boxes within the file. This includes any initial signature required by the specific file format. A “box” may be an object-oriented building block defined by a unique type identifier and length. Typically, a presentation is contained in one file, and the media presentation is self-contained. The movie container (movie box) may contain the metadata of the media and the video and audio frames may be contained in the media data container and could be in other files.

A representation (motion sequence) may be contained in several files, sometimes referred to as segments. Timing and framing (position and size) information is generally in the ISO base media file and the ancillary files may essentially use any format. This presentation may be ‘local’ to the system containing the presentation, or may be provided via a network or other stream delivery mechanism.

When media is delivered over a streaming protocol, the media may need to be transformed from the way it is represented in the file. One example of this is when media is transmitted over the Real-time Transport Protocol (RTP). In the file, for example, each frame of video is stored contiguously as a file-format sample. In RTP, packetization rules specific to the codec used must be obeyed to place these frames in RTP packets. A streaming server may be configured to calculate such packetization at run-time. However, there is support for the assistance of the streaming servers.

This disclosure describes techniques for switching between adaptation sets during playback (also referred to as playout) of media data that is retrieved via streaming, e.g., using techniques of DASH. For example, during streaming, a user may wish to switch languages for audio and/or subtitles, view an alternative camera angle, or increase or decrease relative amounts of depths for 3D video data. To accommodate the user, a client device may, after having already retrieved a certain amount of media data from a first adaptation set, switch to a second, different adaptation set including media data of the same type as the first adaptation set. The client device may continue to play out media data retrieved from the first adaptation set, at least until after a switch point of the second adaptation set has been decoded. For instance, for video data, the switch point may correspond to an instantaneous decoder refresh (IDR) picture, a clean random access (CRA) picture, or other random access point (RAP) picture.

It should be understood that the techniques of this disclosure are particularly directed to switching between adaptation sets, and not just representations within an adaptation set. Whereas prior techniques allow a client device to switch between representations of a common adaptation set, e.g., to adapt to fluctuations in available network bandwidth, the techniques of this disclosure are directed to switching between adaptation sets themselves. This adaptation set switching allows a user to enjoy a more pleasant experience, e.g., due to an uninterrupted playback experience, as described below. Conventionally, if a user wanted to switch to a different adaptation set, playback of media data would need to be interrupted, causing an unpleasant user experience. That is, the user would need to completely stop playback, select a different adaptation set (e.g., camera angle and/or language for audio or timed text), then restart playback from the beginning of the media content. To get back to the previous play position (that is, the playback position when media playback was interrupted in order to switch adaptation sets), the user would need to enter a trick mode (e.g., fast forward) and manually find the previous play position.

Moreover, interrupting the playback of the media data leads to abandoning of previously retrieved media data. That is, to perform streaming media retrieval, client devices typically buffer media data well ahead of the current playback position. In this manner, if a switch between representations of an adaptation set needs to occur (e.g., in response to bandwidth fluctuations), there is sufficient media data stored in the buffer to allow for the switch to occur without interrupting playback. However, in the scenario described above, the buffered media data would be completely wasted. In particular, not only would the buffered media data for the current adaptation set be discarded, but also, buffered media data for other adaptation sets that are not being switch would also be discarded. For example, if a user wanted to switch from English language audio to Spanish language audio, playback would be interrupted, and both the English language audio and corresponding video data would be discarded. Then, after switching to the Spanish language audio adaptation set, the client device would again retrieve the very video data that was previously discarded.

The techniques of this disclosure, on the other hand, allow for a switch between adaptation sets during media streaming, e.g., without interrupting playback. For example, a client device may have retrieved media data from a first adaptation set (and more particularly, a representation of the first adaptation set), and may be presenting media data from the first adaptation set. While presenting media data from the first adaptation set, the client device may receive a request to switch to a second, different adaptation set. The request may originate from an application executed by the client device, in response to input from a user.

For example, the user may wish to switch to audio of a different language, in which case the user may submit a request to change audio languages. As another example, the user may wish to switch to timed text of a different language, in which case the user may submit a request to change timed text (e.g., subtitle) languages. As yet another example, the user may wish to switch camera angles, in which case the user may submit a request to change camera angles (and each adaptation set may correspond to a particular camera angle). Switching camera angles may be to simply see video from a different perspective, or to change a second (or other additional) view angle, e.g., for increasing or decreasing relative depth displayed during 3D playback.

In response to the request, the client device may retrieve media data from the second adaptation set. In particular, the client device may retrieve media data from a representation from the second adaptation set. The retrieved media data may include a switch point (e.g., a random access point). The client device may continue to present media data from the first adaptation set until an actual playout time has met or exceeded the playout time for the switch point of the second adaptation set. In this manner, the client device may utilize the buffered media data of the first adaptation set, as well as avoid interrupting playout during the switch from the first adaptation set to the second adaptation set. In other words, the client device may begin presenting media data from the second adaptation set after an actual playout time has met or exceeded a playout time for the switch point of the second adaptation set.

When switching between adaptation sets, the client device may determine the position of the switch point of the second adaptation set. For example, the client device may refer to a manifest file, such as a media presentation description (MPD), that defines the position of the switch point in the second adaptation set. Typically, representations of a common adaptation set are temporally aligned, such that segment boundaries in each of the representations of the common adaptation set occur at the same playback time. Such cannot be said of different adaptation sets, however. That is, although segments of representations of a common adaptation set may be temporally aligned, segments of representations of different adaptation sets are not necessarily temporally aligned. Therefore, determining the location of a switch point when switching from a representation of one adaptation set to a representation of another adaptation set can be difficult.

The client device may therefore refer to the manifest file to determine segment boundaries for both a representation (e.g., a current representation) of the first adaptation set, as well as a representation of the second adaptation set. The segment boundaries generally refer to the start and end playback times for of media data contained within a segment. Because segments are not necessarily temporally aligned between different adaptation sets, the client device may need to retrieve media data for two segments that overlap in time, where the two segments are from representations of different adaptation sets.

The client device may also attempt to find a switch point in the second adaptation set that is closest to the playback time at which the request to switch to the second adaptation set was received. Typically, the client device attempts to find a switch point in the second adaptation set that is also later, in terms of playback time, than the time at which the request to switch to the second adaptation set was received. In certain instances, however, the switch point may occur at a position that is unacceptably far from the playback time at which the request to switch between adaptation sets was received; typically, this is only when the adaptation set to be switched includes timed text (e.g., for subtitles). In such instances, the client device may request a switch point that is earlier in playback time than the time at which the request to switch was received.

The techniques of this disclosure may be applicable to network streaming protocols, such as HTTP streaming, e.g., in accordance with dynamic adaptive streaming over HTTP (DASH). In HTTP streaming, frequently used operations include GET and partial GET. The GET operation retrieves a whole file associated a given uniform resource locator (URL) or other identifier, e.g., URI. The partial GET operation receives a byte range as an input parameter and retrieves a continuous number of bytes of a file corresponding to the received byte range. Thus, movie fragments may be provided for HTTP streaming, because a partial GET operation can get one or more individual movie fragments. Note that, in a movie fragment, there can be several track fragments of different tracks. In HTTP streaming, a media representation may be a structured collection of data that is accessible to the client. The client may request and download media data information to present a streaming service to a user.

In the example of streaming 3GPP data using HTTP streaming, there may be multiple representations for video and/or audio data of multimedia content. The manifest of such representations may be defined in a Media Presentation Description (MPD) data structure. A media representation may correspond to a structured collection of data that is accessible to an HTTP streaming client device. The HTTP streaming client device may request and download media data information to present a streaming service to a user of the client device. A media representation may be described in the MPD data structure, which may include updates of the MPD.

Each period may contain one or more representations for the same media content. A representation may be one of a number of alternative encoded versions of audio or video data. The representations may differ by various characteristics, such as encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group, which may be indicated by a group attribute in the MPD. Representations in the same group are generally considered alternatives to each other. For example, each representation of video data for a particular period may be assigned to the same group, such that any of the representations may be selected for decoding to display video data of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL). The MPD may provide the identifiers for each segment. In some examples, the MPD may also provide byte ranges in the form of a range attribute, which may correspond to the data for a segment within a file accessible by the URL or URI.

Each representation may also include one or more media components, where each media component may correspond to an encoded version of one individual media type, such as audio, video, and/or timed text (e.g., for closed captioning). Media components may be time-continuous across boundaries of consecutive media segments within one representation. Thus, a representation may correspond to an individual file or a sequence of segments, each of which may include the same coding and rendering characteristics.

The techniques of this disclosure, in some examples, may provide one or more benefits. For example, the techniques of this disclosure allow switching between adaptation sets, which may permit a user to switch between media of the same type on the fly. That is, rather than stopping playback to change between adaptation sets, the user may request to switch between adaptation sets for a type of media (e.g., audio, timed text, or video), and a client device may perform the switch seamlessly. This may avoid wasting buffered media data while also avoiding gaps or pauses during playback. Accordingly, the techniques of this disclosure may provide a more satisfying user experience, while also avoiding excess consumption of network bandwidth.

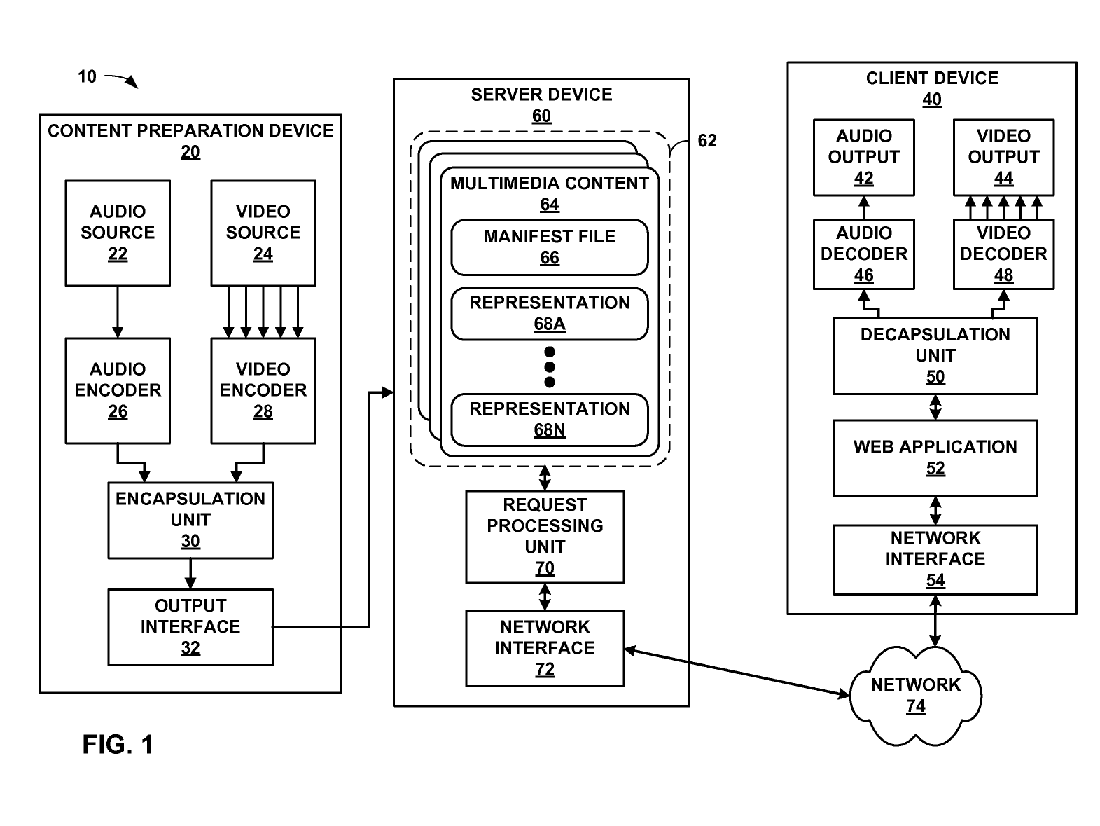

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device. In some examples, content preparation device 20 may distribute prepared content to a plurality of server devices, including server device 60. Similarly, client device 40 may communicate with a plurality of server devices, including server device 60, in some examples.

As described in greater detail below, client device 40 may be configured to perform certain techniques of this disclosure. For example, client device 40 may be configured to switch between adaptation sets during playback of media data. Client device 40 may provide a user interface by which a user can submit a request to switch between adaptation sets for media of a particular type, e.g., audio, video, and/or timed text. In this manner, client device 40 may receive a request to switch between adaptation sets for media data of the same type. For example, a user may request to switch from an adaptation set including audio or timed text data of a first language to an adaptation set including audio or timed text data of a second, different language. As another example, a user may request to switch from an adaptation set including video data for a first camera angle to an adaptation set including video data for a second, different camera angle.

Content preparation device 20, in the example of FIG. 1, includes audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured by audio source 22 contemporaneously with video data captured by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

As with many video coding standards, H.264/AVC defines the syntax, semantics, and decoding process for error-free bitstreams, any of which conform to a certain profile or level. H.264/AVC does not specify the encoder, but the encoder is tasked with guaranteeing that the generated bitstreams are standard-compliant for a decoder. In the context of video coding standard, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and macroblock (MB) processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile. Various representations of multimedia content may be provided, to accommodate various profiles and levels of coding within H.264, as well as to accommodate other coding standards, such as the upcoming High Efficiency Video Coding (HEVC) standard.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a particular level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define, for example, limitations on the number of blocks that need to be processed, decoded picture buffer (DPB) size, coded picture buffer (CPB) size, vertical motion vector range, maximum number of motion vectors per two consecutive MBs, and whether a B-block can have sub-block partitions less than 8×8 pixels. In this manner, a decoder may determine whether the decoder is capable of properly decoding the bitstream.

Video compression standards such as ITU-T H.261, H.262, H.263, MPEG-1, MPEG-2. H.264/MPEG-4 part 10, and the upcoming High Efficiency Video Coding (HEVC) standard, make use of motion compensated temporal prediction to reduce temporal redundancy. The encoder, such as video encoder 28, may use a motion compensated prediction from some previously encoded pictures (also referred to herein as frames) to predict the current coded pictures according to motion vectors. There are three major picture types in typical video coding. They are Intra coded picture (“I-pictures” or “I-frames”), Predicted pictures (“P-pictures” or “P-frames”) and Bi-directional predicted pictures (“B-pictures” or “B-frames”). P-pictures may use the reference picture before the current picture in temporal order. In a B-picture, each block of the B-picture may be predicted from one or two reference pictures. These reference pictures could be located before or after the current picture in temporal order.

Parameter sets generally contain sequence-layer header information in sequence parameter sets (SPS) and the infrequently changing picture-layer header information in picture parameter sets (PPS). With parameter sets, this infrequently changing information need not be repeated for each sequence or picture; hence, coding efficiency may be improved. Furthermore, the use of parameter sets may enable out-of-band transmission of header information, avoiding the need for redundant transmissions to achieve error resilience. In out-of-band transmission, parameter set NAL units are transmitted on a different channel than the other NAL units.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise a combination of audio data and video data. e.g., one or more audio elementary stream and one or more video elementary streams. Each PES packet may include a stream_id that identifies the elementary stream to which the PES packet belongs. Encapsulation unit 30 is responsible for assembling elementary streams into video files of various representations.

Encapsulation unit 30 receives PES packets for elementary streams of a representation from audio encoder 26 and video encoder 28 and forms corresponding network abstraction layer (NAL) units from the PES packets. In the example of H.264/AVC (Advanced Video Coding), coded video segments are organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units.

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission, direct transmission, or storage media. In the example of FIG. 1, server device 60 includes storage medium 62 that stores various multimedia contents 64, each including a respective manifest file 66 and one or more representations 68A-68N (representations 68). In accordance with the techniques of this disclosure, portions of manifest file 66 may be stored in separate locations, e.g., locations of storage medium 62 or another storage medium, potentially of another device of network 74 such as a proxy device.

Representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces, including network interface 72. Furthermore, any or all of the features of server device 60 may be implemented on other devices of a content distribution network, such as routers, bridges, proxy devices, switches, or other devices. In some examples, intermediate devices of a content distribution network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment. In some examples, byte ranges of a segment may be specified using partial GET requests. In other examples, in accordance with the techniques of this disclosure, byte ranges of a segment may be specified as part of a URL for the segment, e.g., according to a generic template.

Request processing unit 70 may further be configured to service HTTP HEAD requests to provide header data of a segment of one of representations 68. In any case, request processing unit 70 may be configured to process the requests to provide requested data to a requesting device, such as client device 40. Furthermore, request processing unit 70 may be configured to generate a template for constructing URLs that specify byte ranges, provide information indicating whether the template is required or optional, and provide information indicating whether any byte range is acceptable or if only a specific set of byte ranges is permitted. When only specific byte ranges are permitted, request processing unit 70 may provide indications of the permitted byte ranges.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

Web application 52 of client device 40 may comprise a web browser executed by a hardware-based processing unit of client device 40, or a plug-in to such a web browser. References to web application 52 should generally be understood to include either a web application, such as a web browser, a standalone video player, or a web browser incorporating a playback plug-in to the web browser. Web application 52 may retrieve configuration data (not shown) of client device 40 to determine decoding capabilities of video decoder 48 and rendering capabilities of video output 44 of client device 40.

The configuration data may also include any or all of a default language preference selected by a user of client device 40, one or more default camera perspectives, e.g., for depth preferences set by the user of client device 40, and/or a rating preference selected by the user of client device 40. Web application 52 may comprise, for example, a web browser or a media client configured to submit HTTP GET and partial GET requests. Web application 52 may correspond to software instructions executed by one or more processors or processing units (not shown) of client device 40. In some examples, all or portions of the functionality described with respect to web application 52 may be implemented in hardware, or a combination of hardware, software, and/or firmware, where requisite hardware may be provided to execute instructions for software or firmware.

Web application 52 may compare the decoding and rendering capabilities of client device 40 to characteristics of representations 68 indicated by information of manifest file 66. Web application 52 may initially retrieve at least a portion of manifest file 66 to determine characteristics of representations 68. For example, web application 52 may request a portion of manifest file 66 that describes characteristics of one or more adaptation sets. Web application 52 may select a subset of representations 68 (e.g., an adaptation set) having characteristics that can be satisfied by the coding and rendering capabilities of client device 40. Web application 52 may then determine bitrates for representations in the adaptation set, determine a currently available amount of network bandwidth, and retrieve segments (or byte ranges) from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, web application 52 may retrieve data from relatively high bitrate representations, whereas when available network bandwidth is low, web application 52 may retrieve data from relatively low bitrate representations. In this manner, client device 40 may stream multimedia data over network 74 while also adapting to changing network bandwidth availability of network 74.

As noted above, in some examples, client device 40 may provide user information to, e.g., server device 60 or other devices of a content distribution network. The user information may take the form of a browser cookie, or may take other forms. Web application 52, for example, may collect a user identifier, user identifier, user preferences, and/or user demographic information, and provide such user information to server device 60. Web application 52 may then receive a manifest file associated with targeted advertisement media content, to use to insert data from the targeted advertisement media content into media data of requested media content during playback. This data may be received directly as a result of a request for the manifest file, or a manifest sub-file, or this data may be received via an HTTP redirect to an alternative manifest file or sub-file (based on a supplied browser cookie, used to store user demographics and other targeting information).

At times, a user of client device 40 may interact with web application 52 using user interfaces of client device 40, such as a keyboard, mouse, stylus, touchscreen interface, buttons, or other interfaces, to request multimedia content, such as multimedia content 64. In response to such requests from a user, web application 52 may select one of representations 68 based on, e.g., decoding and rendering capabilities of client device 40. To retrieve data of the selected one of representations 68, web application 52 may sequentially request specific byte ranges of the selected one of representations 68. In this manner, rather than receiving a full file through one request, web application 52 may sequentially receive portions of a file through multiple requests.

In some examples, server device 60 may specify a generic template for URLs from client devices, such as client device 40. Client device 40, in turn, may use the template to construct URLs for HTTP GET requests. In the DASH protocol, URLs are formed either by listing them explicitly within each segment, or by giving an URLTemplate, which is a URL containing one or more well-known patterns, such as $$, SRepresentationID$, $Index$. $Bandwidth$, or $Time$ (described by Table 9 of the present draft of DASH.) Before making a URL request, client device 40 may substitute text strings such as ‘$$’, the representation id, the index of the segment, etc., into the URLTemplate to general the final URL to be fetched. This disclosure defines several additional XML fields that may be added to the SegmentInfoDefault element of a DASH file, e.g., in an MPD for multimedia content, such as manifest file 66 for multimedia content 64.

In response to requests submitted by web application 52 to server device 60, network interface 54 may receive and provide data of received segments of a selected representation to web application 52. Web application 52 may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream. e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, web application 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, web application 52, and/or decapsulation unit 50 may comprise an integrated circuit, a microprocessor, and/or a wireless communication device, such as a cellular telephone.

In this manner, client device 40 represents an example of a device for retrieving media data, where the device may include one or more processors configured to retrieve media data from a first adaptation set including media data of a first type, present media data from the first adaptation set, in response to a request to switch to a second adaptation set including media data of the first type: retrieve media data from the second adaptation set including a switch point of the second adaptation set, and present media data from the second adaptation set after an actual playout time has met or exceeded a playout time for the switch point.

The techniques of this disclosure may be applied in the following context: data has been fully downloaded for period P1, and downloads have started in a next period P2. In one example, a data buffer includes approximately 20 seconds of playback worth of data for P1 and 5 seconds of playback worth of data for P2, and the user is currently viewing content of P1. At this time, the user initiates an adaptation set change, e.g., changing audio from English to French. In conventional techniques, a problem may arise in that if a source component (e.g., web application 52) were to reflect this change only for P2, the user would observe the change about 20 seconds later, which is a negative user experience. On the other hand, if changes are reflected on both P1 and P2, then changes in P2 might not be reflected exactly at the start of P2. The techniques of this disclosure may offer a solution in that a source component (such as request processing unit 70 of server device 60) may reflect changes on both periods P1 and P2, and in order to reflect changes from start of P2, the source component may issue a SEEK event on P2 to the start time of P2. Such a SEEK event may involve additional synchronization logic on the source component side.

The techniques of this disclosure may also be applied in the following context: a user initiates adaptation set changes rapidly, in particular replacing adaptation set A with adaptation set B and then with adaptation set C in quick succession. Problems may arise in that, when the A to B change is processed, adaptation set A would be removed from the client device internal state. So when the B to C change is issued, the change is performed relative to B's download position. The techniques of this disclosure may offer a solution in that a source component may provide a new API, e.g., GetCurrentPlaybackTime(type), that accepts “type” as an argument indicative of the adaptation set type (AUDIO, VIDEO, etc.) and provides playback position for that adaptation set (e.g., in terms of playback time). This new API may be used to determine a switch time. The switch time may be before play start time of an adaptation set. For example, B start time may be at playback time (p-time) 10 seconds, but playback position based on type may be at time 7 seconds. The PKER core algorithm may be changed, because buffer computation logic may be impacted.

Alternatively, a source component may already include logic for feeding the right samples when an adaptation set is replaced. For instance, the client device may be configured to feed sample from adaptation set B only after time 10 seconds, and not before. When the replace operation issued, the source component may check whether playback has started for the adaptation set being replaced. For a B to C adaptation set switch, playback may not yet have started for adaptation set B. If playback has not started, the source component may avoid giving any data samples to renderer for the old adaptation set and issue the following commands: REMOVE (old adaptation set) [In this case REMOVE B], and ADD (new adaptation set) [In this case ADD C]. The impact on the source component should be minimal. Source component may ensure that playback of adaptation set A proceeds if the renderer (e.g., audio output 42 or video output 44) were to request samples at/beyond adaptation set B's switch point. The source component may also validate the starting position of C relative to A.

In yet another example context, a user may switch from adaptation set A to adaptation set B, then rapidly back to adaptation set A. In this case, client device 40 may avoid presenting samples of adaptation set B to the user. In accordance with the techniques of this disclosure, the source component may detect that playback has not started on B and, similar to the scenario described above, stop B's samples from reaching the renderer. Thus, the source component may submit the following commands: REMOVE B and, immediately, ADD A. When A is added, global playback statistics may be used to determine start time of A again, which might fall within data that is already present. In this scenario, the source component may reject SELECT requests until a currently available time.

For example, suppose A's data was downloaded until time 30 sec (and playback is currently at 0 sec). The user may replace adaptation set A with adaptation set B, and the switch time may have been at 2 sec. A's data from 2 to 30 sec may be purged. However, when A is added back, it would start with time 0 and issue a SELECT request. The source component may reject this SELECT request. Then, starting at time 2 seconds, meta-data may be requested. The source component would approve selection at time 2 seconds.

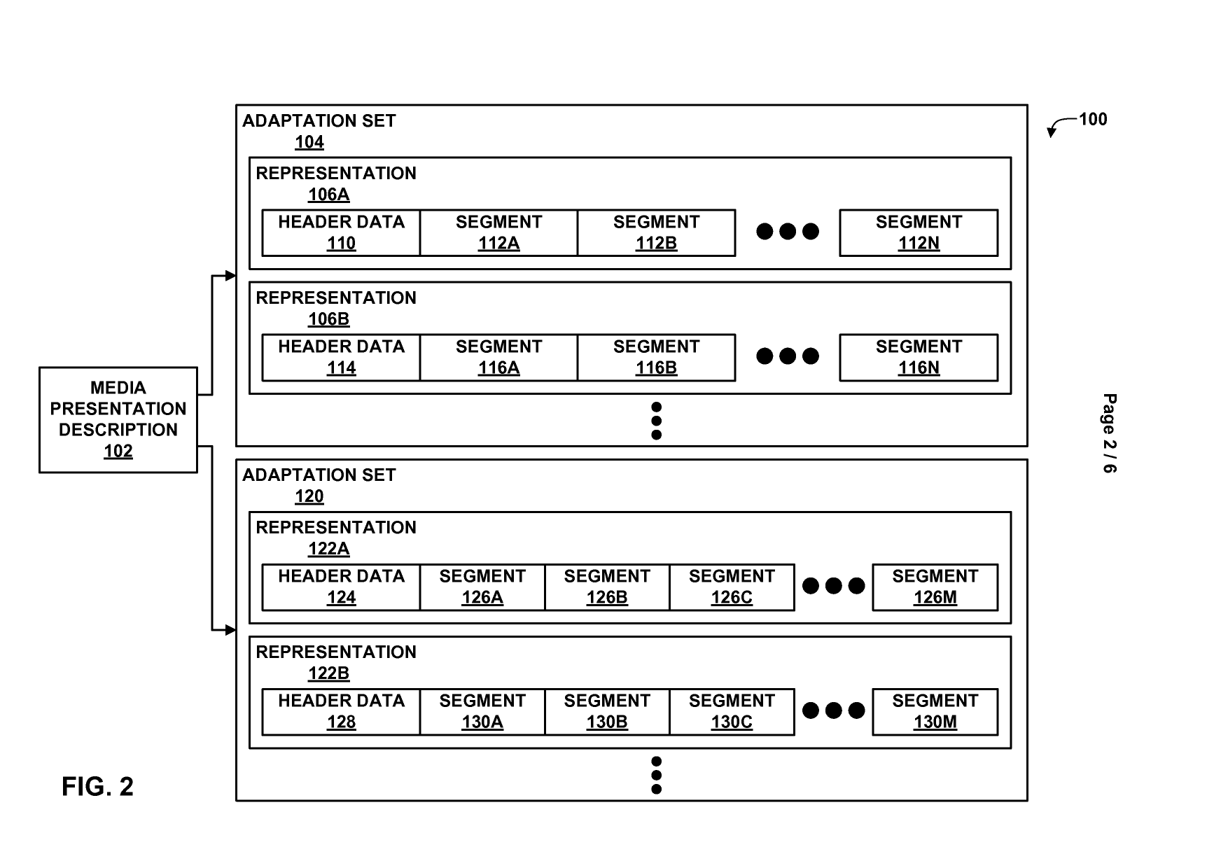

FIG. 2 is a conceptual diagram illustrating elements of an example multimedia content 100. Multimedia content 100 may correspond to multimedia content 64 (FIG. 1), or another multimedia content stored in storage medium 62. In the example of FIG. 2, multimedia content 100 includes media presentation description (MPD) 102 and adaptation sets 104, 120. Adaptation sets 104, 120 include respective pluralities of representations. In this example, adaptation set 104 includes representations 106A, 106B, and so on (representations 106), while adaptation set 120 includes representations 122A, 122B, and so on (representations 122). Representation 106A includes optional header data 110 and segments 112A-112N (segments 112), while representation 106B includes optional header data 114 and segments 116A-116N (segments 116). Likewise, representations 122 include respective optional header data 124, 128. Representation 122A includes segments 126A-126M (segments 126), while representation 122B includes segments 130A-130M (segments 130). The letter N is used to designate the last segment in each of representations 106 as a matter of convenience. The letter M is used to designate the last segment in each of representations 122. M and N may have different values or the same value.

Segments 112, 116 are illustrated as having the same length to indicate that segments of the same adaptation set may be temporally aligned. Similarly, segments 126, 130 are illustrated as having the same length. However, segments 112, 116 have different lengths than segments 126, 130, to indicate that segments of different adaptation sets are not necessarily temporally aligned.

MPD 102 may comprise a data structure separate from representations 106. MPD 102 may correspond to manifest file 66 of FIG. 1. Likewise, representations 106 may correspond to representations 68 of FIG. 1. In general, MPD 102 may include data that generally describes characteristics of representations 106, such as coding and rendering characteristics, adaptation sets, a profile to which MPD 102 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 110, when present, may describe characteristics of segments 12, e.g., temporal locations of random access points, which of segments 112 includes random access points, byte offsets to random access points within segments 112, uniform resource locators (URLs) of segments 112, or other aspects of segments 112. Header data 114, when present, may describe similar characteristics for segments 116. Similarly, header data 124 may describe characteristics of segments 126, while header data 128 may describe characteristics of segments 130. Additionally or alternatively, such characteristics may be fully included within MPD 102.

Segments, such as segments 112, include one or more coded video samples, each of which may include frames or slices of video data. For segments including video data, each of the coded video samples may have similar characteristics, e.g., height, width, and bandwidth requirements. Such characteristics may be described by data of MPD 102, though such data is not illustrated in the example of FIG. 2. MPD 102 may include characteristics as described by the 3GPP Specification, with the addition of any or all of the signaled information described in this disclosure.

Each of segments 112, 116 may be associated with a unique uniform resource identifier (URI), e.g., a uniform resource locator (URL). Thus, each of segments 112, 116 may be independently retrievable using a streaming network protocol, such as DASH. In this manner, a destination device, such as client device 40, may use an HTTP GET request to retrieve segments 112 or 124. In some examples, client device 40 may use HTTP partial GET requests to retrieve specific byte ranges of segments 112 or 124.

In accordance with the techniques of this disclosure, two or more adaptation sets may include the same type of media content. However, the actual media of the adaptation sets may be different. For example, adaptation sets 104, 120 may include audio data. That is, segments 112, 116, 126, 130 may include data representative of encoded audio data. However, adaptation set 104 may correspond to English language audio data, whereas adaptation set 120 may correspond to Spanish language audio data. As another example, adaptation sets 104, 120 may include data representative of encoded video data, but adaptation set 104 may correspond to a first camera angle, whereas adaptation set 120 may correspond to a second, different camera angle. As yet another example, adaptation sets 104, 120 may include data representative of timed text (e.g., for subtitles), but adaptation set 104 may include English language timed text, whereas adaptation set 120 may include Spanish language timed text. Of course. English and Spanish are provided merely as examples; in general, any languages may be included in adaptation sets including audio and/or timed text data, and two or more alternative adaptation sets may be provided.

In accordance with the techniques of this disclosure, a user may initially select adaptation set 104. Alternatively, client device 40 may select adaptation set 104 based on, e.g., configuration data, such as default user preferences. In any case, client device 40 may initially retrieve data from one of representations 106 of adaptation set 104. In particular, client device 40 may submit requests to retrieve data from one or more segments of one of representations 106. Assuming, for example, that the amount of available network bandwidth best corresponds to the bitrate of representation 106A, client device 40 may retrieve data from one or more of segments 112. In response to bandwidth fluctuations, client device 40 may switch to another of representations 106, e.g., representation 106B. That is, after an increase or decrease in available network bandwidth, client device 40 may begin retrieving data from one or more of segments 116, utilizing bandwidth adaptation techniques.

Assuming that representation 106A is the current representation, and that client device 40 starts from the beginning of representation 106A, client device 40 may submit one or more requests to retrieve data of segment 112A. For instance, client device 40 may submit an HTTP GET request to retrieve segment 112A, or several HTTP partial GET requests to retrieve contiguous portions of segment 112A. After submitting one or more requests to retrieve data of segment 112A, client device 40 may submit one or more requests to retrieve data of segment 112B. In particular, client device 40 may accumulate data of representation 106A, in this example, until a sufficient amount of data has been buffered that permits client device 40 to begin decoding and presenting data in the buffer.

As discussed above, client device 40 may periodically determine available amounts of network bandwidth, and if necessary, perform bandwidth adaptation between representations 106 of adaptation set 104. Typically, such bandwidth adaptation is simplified because segments of representations 106 are temporally aligned. For example, segment 112A and segment 116A include data that starts and ends at the same relative playback times. Thus, in response to a fluctuation in available network bandwidth, client device 40 may switch between representations 106 at segment boundaries.

In accordance with the techniques of this disclosure, client device 40 may receive a request to switch adaptation sets, e.g., from adaptation set 104 to adaptation set 120. For example, if adaptation set 104 includes audio or timed text data in English and adaptation set 120 includes audio or timed text data in Spanish, client device 40 may receive a request from a user to switch from adaptation set 104 to adaptation set 120, after the user determines that Spanish is more preferable than English at a particular time. As another example, if adaptation set 104 includes video data from a first camera angle and adaptation set 120 includes video data from a second, different camera angle, client device 40 may receive a request from a user to switch from adaptation set 104 to adaptation set 120, after the user determines that the second camera angle is more preferable than the first camera angle at a particular time.

In order to effect the switch from adaptation set 104 to adaptation set 120, client device 40 may refer to data of MPD 102. The data of MPD 102 may indicate starting and ending playback times of segments of representations 122. Client device 40 may determine a playback time at which the request to switch between adaptation sets was received, and compare this determined playback time to the playback time of a next switch point of adaptation set 120. If the playback time of the next switch point is sufficiently close to the determined playback time at which the switch request was received, client device 40 may determine an available amount of network bandwidth and select one of representations 122 having a bitrate that is supported by the available amount of network bandwidth, then request data of the selected one of representations 122 including the switch point.

For example, suppose that client device 40 receives the request to switch between adaptation sets 104 and 120 during playback of segment 112B. Client device 40 may determine that segment 126C, which immediately follows segment 126B in representation 122A, includes a switch point at the beginning (in terms of temporal playback time) of segment 126C. In particular, client device 40 may determine the playback time of the switch point of segment 126C from data of MPD 102. Moreover, client device 40 may determine that the switch point of segment 126C follows the playback time at which the request to switch between adaptation sets was received. Furthermore, client device 40 may determine that representation 122A has a bitrate that is most appropriate for the determined amount of network bandwidth (e.g., is higher than bitrates for all other representations 122 in adaptation set 120, without exceeding the determined amount of available network bandwidth).

In the example described above, client device 40 may have buffered data of segment 112B of representation 106A of adaptation set 104. However, in light of the request to switch between adaptation sets, client device 40 may request data of segment 126C. Client device 40 may retrieve data of segment 112B substantially simultaneously with retrieving data of segment 126C. That is, because segment 112B and segment 126C overlap in terms of playback time, as shown in the example of FIG. 2, it may be necessary to retrieve data of segment 126C at substantially the same time as retrieving data of segment 112B. Thus, retrieving data for switching between adaptation sets may differ from retrieving data for switching between two representations of the same adaptation set at least in that data for two segments of different adaptation sets may be retrieved at substantially the same time, rather than serially (as in the case of switching between representations of the same adaptation set, e.g., for bandwidth adaptation).

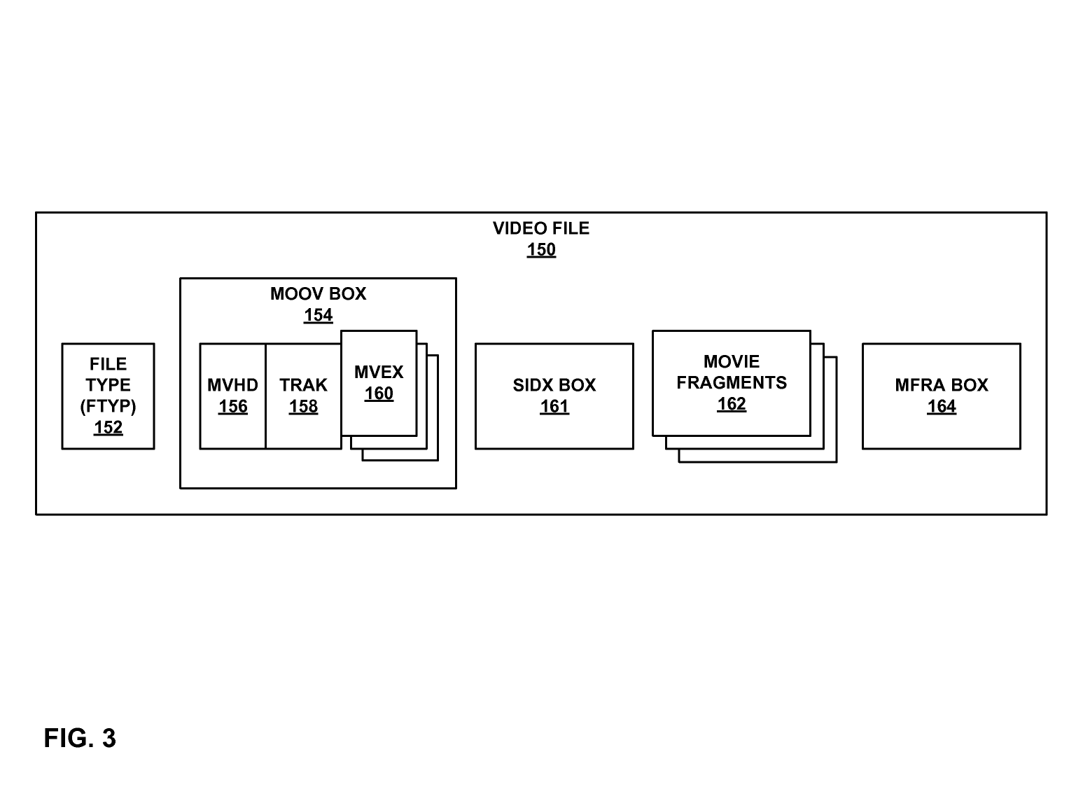

FIG. 3 is a block diagram illustrating elements of an example video file 150, which may correspond to a segment of a representation, such as one of segments 112, 124 of FIG. 2. Each of segments 112, 116, 126, 130 may include data that conforms substantially to the arrangement of data illustrated in the example of FIG. 3. As described above, video files in accordance with the ISO base media file format and extensions thereof store data in a series of objects, referred to as “boxes.” In the example of FIG. 3, video file 150 includes file type (FTYP) box 152, movie (MOOV) box 154, movie fragments 162 (also referred to as movie fragment boxes (MOOF)), and movie fragment random access (MFRA) box 164.

Video file 150 generally represents an example of a segment of multimedia content, which may be included in one of representations 106, 122 (FIG. 2). In this manner, video file 150 may correspond to one of segments 112, one of segments 116, one of segments 126, one of segments 130, or a segment of another representation.

In the example of FIG. 3, video file 150 includes one segment index (SIDX) box 161. In some examples, video file 150 may include additional SIDX boxes, e.g., between movie fragments 162. In general, SIDX boxes, such as SIDX box 161, include information that describes byte ranges for one or more of movie fragments 162. In other examples, SIDX box 161 and/or other SIDX boxes may be provided within MOOV box 154, following MOOV box 154, preceding or following MFRA box 164, or elsewhere within video file 150.

File type (FTYP) box 152 generally describes a file type for video file 150. File type box 152 may include data that identifies a specification that describes a best use for video file 150. File type box 152 may be placed before MOOV box 154, movie fragment boxes 162, and MFRA box 164.

MOOV box 154, in the example of FIG. 3, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 162, which may be referenced by data of TRAK box 158.

In some examples, video file 150 may include more than one track, although this is not necessary for the DASH protocol to work. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 162, e.g., to signal that video file 150 includes movie fragments 162, in addition to video data included within MOOV box 154, if any. In the context of streaming video data, coded video pictures may be included in movie fragments 162 rather than in MOOV box 154. Accordingly, all coded video samples may be included in movie fragments 162, rather than in MOOV box 154.

MOOV box 154 may include a number of MVEX boxes 160 equal to the number of movie fragments 162 in video file 150. Each of MVEX boxes 160 may describe characteristics of a corresponding one of movie fragments 162. For example, each MVEX box may include a movie extends header box (MEHD) box that describes a temporal duration for the corresponding one of movie fragments 162.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units which contain the information to construct all the pixels of the access unit and other associated non-VCL NAL units, such as SEI messages. Accordingly, encapsulation unit 30 may include a sequence data set, which may include sequence level SEI messages, in one of movie fragments 162. Encapsulation unit 30 may further signal the presence of a sequence data set and/or sequence level SEI messages as being present in one of movie fragments 162 within the one of MVEX boxes 160 corresponding to the one of movie fragments 162.

Movie fragments 162 may include one or more coded video pictures. In some examples, movie fragments 162 may include one or more groups of pictures (GOPs), each of which may include a number of coded video pictures, e.g., frames or pictures. In addition, as described above, movie fragments 162 may include sequence data sets in some examples. Each of the movie fragments 162 may include a movie fragment header box (MFHD, not shown in FIG. 3). The MFHD box may describe characteristics of the corresponding movie fragment, such as a sequence number for the movie fragment. Movie fragments 162 may be included in order of sequence number in video file 150.

MFRA box 164 may describe random access points within movie fragments 162 of video file 150. This may assist with performing trick modes, such as performing seeks to particular temporal locations within video file 150. MFRA box 164 is generally optional and need not be included in video files, in some examples. Likewise, a client device, such as client device 40, does not necessarily need to reference MFRA box 164 to correctly decode and display video data of video file 150. MFRA box 164 may include a number of track fragment random access (TFRA) boxes (not shown) equal to the number of tracks of video file 150, or in some examples, equal to the number of media tracks (e.g., non-hint tracks) of video file 150.

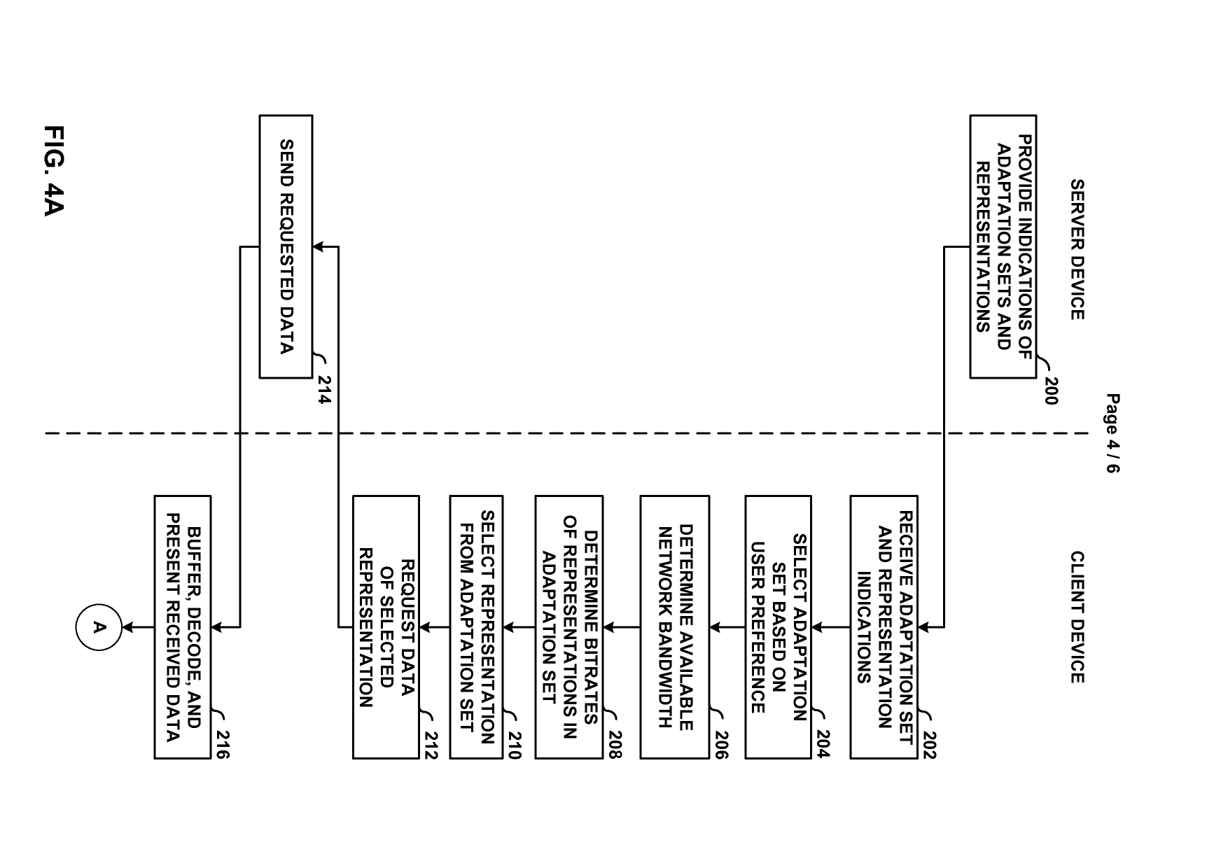

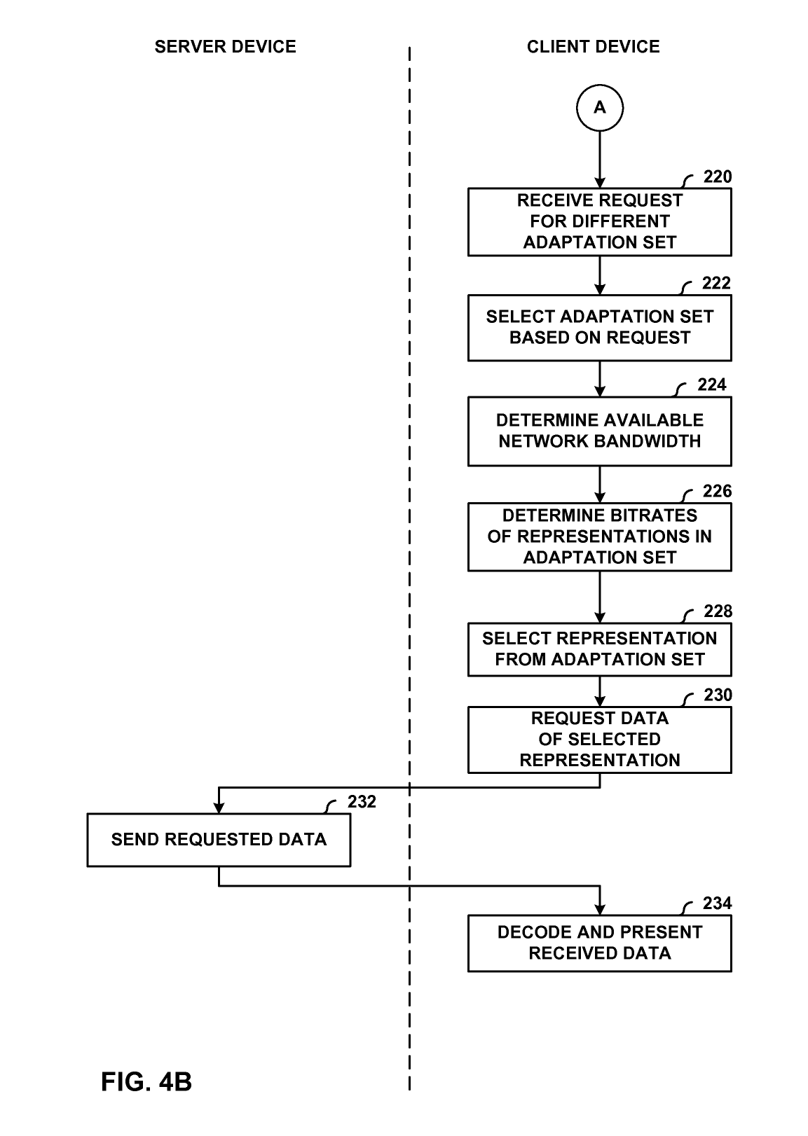

FIGS. 4A and 4B are flowcharts illustrating an example method for switching between adaptation sets during playback in accordance with the techniques of this disclosure. The method of FIGS. 4A and 4B is described with respect to server device 60 (FIG. 1) and client device 40 (FIG. 1). However, it should be understood that other devices may be configured to perform similar techniques. For example, client device 40 may retrieve data from content preparation device 20, in some examples.

Initially, in the example of FIG. 4A, server device 60 provides indications of adaptation sets and representations of the adaptation sets to client device 40 (200). For example, server device 60 may send data for a manifest file, such as an MPD, to client device 40. Although not shown in FIG. 4A, server device 60 may send the indications to client device 40 in response to a request for the indications from client device 40. The indications (e.g., included within a manifest file) may additionally include data defining playback times for starts and ends of segments within the representations, as well as byte ranges for various types of data within the segments. In particular, the indications may indicate a type of data included within each of the adaptation sets, as well as characteristics for that type of data. For example, for adaptation sets including video data, the indications may define a camera angle for the video data included within each of the video adaptation sets. As another example, for adaptation sets including audio data and/or timed text data, the indications may define a language for the audio and/or timed text data.

Client device 40 receives the adaptation set and representation indications from server device 60 (202). Client device 40 may be configured with default preferences for a user, e.g., for any or all of language preferences and/or camera angle preferences. Thus, client device 40 may select adaptation sets of various types of media data based on the user preferences (204). For instance, if the user has selected a language preference, client device 40 may select an audio adaptation set based at least in part on the language preference (as well as other characteristics, such as decoding and rendering capabilities of client device 40 and the coding and rendering characteristics of the adaptation set). Client device 40 may similarly select adaptation sets for both audio and video data, as well as for timed text if a user has elected to display subtitles. Alternatively, client device 40 may receive an initial user selection or a default configuration, rather than using user preferences, to select the adaptation set(s).

After selecting a particular adaptation set, client device 40 may determine an available amount of network bandwidth (206), as well as bitrates of representations in the adaptation set (208). For example, client device 40 may refer to a manifest file for the media content, where the manifest file may define bitrates for the representations. Client device 40 may then select a representation from the adaptation set (210), for instance, based on the bitrates for the representations of the adaptation set and based on the determined amount of available network bandwidth. For instance, client device 40 may select the representation having the highest bitrate of the adaptation set that does not exceed the amount of available network bandwidth.

Client device 40 may similarly select a representation from each of the selected adaptation sets (where the selected adaptation sets may each correspond to a different type of media data, e.g., audio, video, and/or timed text). It should be understood that in some instances, multiple adaptation sets may be selected for the same type of media data. e.g., for stereo or multi-view video data, multiple audio channels for supporting various levels of surround sound or three-dimensional audio arrays, or the like. Client device 40 may select at least one adaptation set, and one representation from each selected adaptation set, for each type of media data to be presented.

Client device 40 may then request data of the selected representation(s) (212). For example, client device 40 may request segments from each of the selected representations using, e.g., HTTP GET or partial GET requests. In general, client device 40 may request data for segments from each of the representations that have playback times that are substantially simultaneous. In response, server device 60 may send the requested data to client device 40 (214). Client device 40 may buffer, decode, and present the received data (216).

Subsequently, client device 40 may receive a request for a different adaptation set (220). For example, a user may elect to switch to a different language for audio or timed text data, or a different camera angle, e.g., to increase or decrease depth for 3D video presentations or to view video from an alternative angle for 2D video presentations. Of course, if alternate viewing angles are provided for 3D video presentations, client device 40 may switch, e.g., two or more video adaptation sets to provide a 3D presentation from an alternate viewing angle.

In any case, after receiving the request for a different adaptation set, client device 40 may select an adaptation set based on the request (222). This selection process may be substantially similar to the selection process described with respect to step 204 above. For instance, client device 40 may select the new adaptation set such that the new adaptation set includes data conforming to the characteristics requested by the user (e.g., language or camera angle), as well as coding and rendering capabilities of client device 40. Client device 40 may also determine an available amount of network bandwidth (224), determine bitrates of representations in the new adaptation set (226), and select a representation from the new adaptation set (228) based on the bitrates of the representations and the available amount of network bandwidth. This representation selection process may conform substantially to the representation selection process described above with respect to steps 206-210.

Client device 40 may then request data of the selected representation (230). In particular, client device 40 may determine a segment including a switch point having a playback time that is later than and closest to the playback time at which the request to switch to the new adaptation set was received. Requesting data of a segment of the representation of the new adaptation set may occur substantially simultaneously with requesting data of a representation of the previous adaptation set, assuming that the segments between the adaptation sets are not temporally aligned. Furthermore, client device 40 may continue to request data from representations of other adaptation sets that were not switched.

In some instances, the representation of the new adaptation set may not have a switch point for an unacceptably long period of time (e.g., a number of seconds or a number of minutes). In such cases, client device 40 may elect to request data of the representation of the new adaptation set including a switch point having a playback time that is earlier than the playback time at which the request to switch adaptation sets was received. Typically, this would only occur for timed text data, which has a relatively low bitrate compared to video and audio data, and therefore, retrieving an earlier switch point will not adversely affect data retrieval or playback.

In any case, server device 60 may send the requested data to client device 40 (232), and client device 40 may decode and present the received data (234). Specifically, client device 40 may buffer the received data, including a switch point of the representation of the new adaptation set, until an actual playback time has met or exceeded the playback time of the switch point. Then, client device 40 may switch from presenting data of the previous adaptation set to presenting data of the new adaptation set. Concurrently, client device 40 may continue decoding and presenting data of other adaptation sets with other media types.

It should be understood that, after selecting a representation of the first adaptation set and before receiving a request to switch to a new adaptation set, client device 40 may periodically perform bandwidth estimation and select a different representation of the first adaptation set, if needed based on the reevaluated amount of network bandwidth. Likewise, after selecting a representation of the new adaptation set, client device 40 may periodically perform bandwidth estimation to determine a subsequent adaptation set.

In this manner, the method of FIGS. 4A and 4B represents an example of a method including retrieving media data from a first adaptation set including media data of a first type, presenting media data from the first adaptation set, in response to a request to switch to a second adaptation set including media data of the first type: retrieving media data from the second adaptation set including a switch point of the second adaptation set, and presenting media data from the second adaptation set after an actual playout time has met or exceeded a playout time for the switch point.

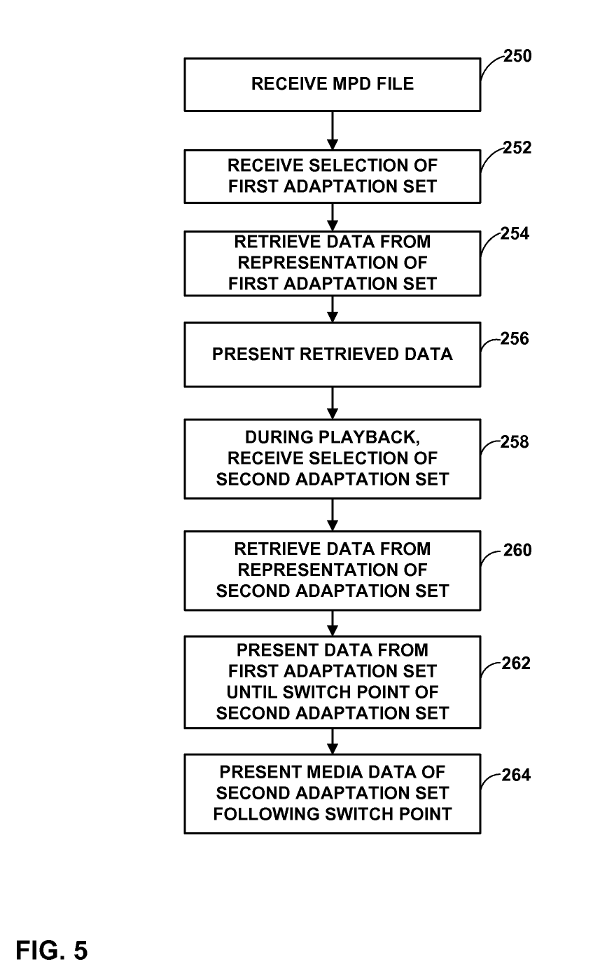

FIG. 5 is a flowchart illustrating another example method for switching between adaptation sets in accordance with the techniques of this disclosure. In this example, client device 40 receives an MPD file (or other manifest file) (250). Client device 40 then receives a selection of a first adaptation set, including media data of a particular type (e.g., audio, timed text, or video) (252). Client device 40 then retrieves data from a representation of the first adaptation set (254) and presents at least some of the retrieved data (256).

During playback of the media data from the first adaptation set, client device 40 receives a selection of a second adaptation set (258). Client device 40 may, therefore, retrieve data from a representation of the second adaptation set (260), and the retrieved data may include a switch point within the representation of the second adaptation set. Thus, client device 40 may continue presenting data from the first adaptation set until a playback time for the switch point of the second adaptation set (262). Then, client device 40 may begin presenting media data of the second adaptation set following the switch point.

Accordingly, the method of FIG. 5 represents an example of a method including retrieving media data from a first adaptation set including media data of a first type, presenting media data from the first adaptation set, in response to a request to switch to a second adaptation set including media data of the first type: retrieving media data from the second adaptation set including a switch point of the second adaptation set, and presenting media data from the second adaptation set after an actual playout time has met or exceeded a playout time for the switch point.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM. CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
retrieving media data from a first adaptation set including media data of a first type;
presenting media data from the first adaptation set; and
in response to a request to switch to a second adaptation set including media data of the first type:
retrieving media data from the second adaptation set including a switch point of the second adaptation set; and
presenting media data from the second adaptation set after an actual playout time has met or exceeded a playout time for the switch point.

2. The method of claim 1, wherein the first type comprises at least one of audio data and subtitle data, wherein the first adaptation set includes a first plurality of representations including media data of the first type in a first language, and wherein the second adaptation set includes a second plurality of representations including media data of the first type in a second language different from the first language.

3. The method of claim 1, wherein the first type comprises video data, wherein the first adaptation set includes a first plurality of representations including video data for a first camera angle, and wherein the second adaptation set includes a second plurality of representations including video data for a second camera angle different from the first camera angle.

4. The method of claim 1, wherein at the time the request to switch to the second adaptation set is received, the playout time for the switch point is less than the actual playout time at the time the request to switch is received plus a threshold value.

5. The method of claim 1, wherein at the time the request to switch to the second adaptation set is received, the playout time for the switch point is greater than the actual playout time at the time the request to switch is received, the method further comprising retrieving data from the first adaptation set and the second adaptation set until a playout time for retrieved media data from the second adaptation set has met or exceeded the actual playout time.

6. The method of claim 1, further comprising:
obtaining a manifest file for the first adaptation set and the second adaptation set; and
determining a playout time for the switch point using data of the manifest file,
wherein retrieving the media data comprises retrieving the media data based at least in part on a comparison of the playout time for the switch point to the actual playout time when the request to switch to the second adaptation set is received.

7. The method of claim 1, further comprising:
obtaining a manifest file for the first adaptation set and the second adaptation set; and
determining a location of the switch point in a representation of the second adaptation set using data of the manifest file.

8. The method of claim 7, wherein the location is at least partially defined by a starting byte in a segment of the representation of the second adaptation set.

9. The method of claim 7, wherein retrieving the media data from the second adaptation set comprises retrieving data of the representation from the second adaptation set including at least the location of the switch point.

10. The method of claim 7, wherein the representation comprises a selected representation, the method further comprising:
determining bitrates for a plurality of representations in the second adaptation set using the manifest file;
determining a current amount of network bandwidth; and
selecting the selected representation from the plurality of the representations such that the bitrate for the selected representation does not exceed the current amount of network bandwidth.

11. A device for retrieving media data, the device comprising one or more processors configured to retrieve media data from a first adaptation set including media data of a first type, present media data from the first adaptation set, and in response to a request to switch to a second adaptation set including media data of the first type:
retrieve media data from the second adaptation set including a switch point of the second adaptation set, and
present media data from the second adaptation set after an actual playout time has met or exceeded a playout time for the switch point.

12. The device of claim 11, wherein the first type comprises at least one of audio data and subtitle data, wherein the first adaptation set includes a first plurality of representations including media data of the first type in a first language, and wherein the second adaptation set includes a second plurality of representations including media data of the first type in a second language different from the first language.

13. The device of claim 11, wherein the first type comprises video data, wherein the first adaptation set includes a first plurality of representations including video data for a first camera angle, and wherein the second adaptation set includes a second plurality of representations including video data for a second camera angle different from the first camera angle.

14. The device of claim 11, wherein at the time the request to switch to the second adaptation set is received, the playout time for the switch point is less than the actual playout time at the time the request to switch is received plus a threshold value.

15. The device of claim 11, wherein at the time the request to switch to the second adaptation set is received, the playout time for the switch point is greater than the actual playout time at the time the request to switch is received, and wherein the one or more processors are further configured to retrieve data from the first adaptation set and the second adaptation set until playout time for retrieved media data from the second adaptation set has met or exceeded the actual playout time.

16. The device of claim 11, wherein the one or more processors are further configured to obtain a manifest file for the first adaptation set and the second adaptation set, determine a playout time for the switch point using data of the manifest file, and retrieve the media data based at least in part on a comparison of the playout time for the switch point to the actual playout time when the request to switch to the second adaptation set is received.

17. The device of claim 11, wherein the one or more processors are further configured to obtain a manifest file for the first adaptation set and the second adaptation set, and determine a location of the switch point in a representation of the second adaptation set using data of the manifest file.

18. The device of claim 17, wherein the location is at least partially defined by a starting byte in a segment of the representation of the second adaptation set.

19. The device of claim 17, wherein the one or more processors are configured to retrieve data of the representation of the second adaptation set including at least the location of the switch point.

20. The device of claim 17, wherein the representation comprises a selected representation, and wherein the one or more processors are further configured to determine bitrates for a plurality of representations in the second adaptation set using the manifest file, determine a current amount of network bandwidth, and select the selected representation from the plurality of the representations such that the bitrate for the selected representation does not exceed the current amount of network bandwidth.

21. A device for retrieving media data, the device comprising:
means for retrieving media data from a first adaptation set including media data of a first type;
means for presenting media data from the first adaptation set;
means for retrieving, in response to a request to switch to a second adaptation set including media data of the first type, media data from the second adaptation set including a switch point of the second adaptation set; and
means for presenting, in response to the request, media data from the second adaptation set after an actual playout time has met or exceeded a playout time for the switch point.

22. The device of claim 21, wherein the first type comprises at least one of audio data and subtitle data, wherein the first adaptation set includes a first plurality of representations including media data of the first type in a first language, and wherein the second adaptation set includes a second plurality of representations including media data of the first type in a second language different from the first language.

23. The device of claim 21, wherein the first type comprises video data, wherein the first adaptation set includes a first plurality of representations including video data for a first camera angle, and wherein the second adaptation set includes a second plurality of representations including video data for a second camera angle different from the first camera angle.

24. The device of claim 21, wherein at the time the request to switch to the second adaptation set is received, the playout time for the switch point is less than the actual playout time at the time the request to switch is received plus a threshold value.

25. The device of claim 21, wherein at the time the request to switch to the second adaptation set is received, the playout time for the switch point is greater than the actual playout time at the time the request to switch is received, further comprising means for retrieving data from the first adaptation set and the second adaptation set until playout time for retrieved media data from the second adaptation set has met or exceeded the actual playout time.

26. The device of claim 21, further comprising:
means for obtaining a manifest file for the first adaptation set and the second adaptation set; and
means for determining a playout time for the switch point using data of the manifest file,
wherein the means for retrieving the media data comprises means for retrieving the media data based at least in part on a comparison of the playout time for the switch point to the actual playout time when the request to switch to the second adaptation set is received.

27. The device of claim 21, further comprising:
means for obtaining a manifest file for the first adaptation set and the second adaptation set; and
means for determining a location of the switch point in a representation of the second adaptation set using data of the manifest file.

28. The device of claim 27, wherein the location is at least partially defined by a starting byte in a segment of the representation of the second adaptation set.

29. The device of claim 27, wherein the means for retrieving the media data from the second adaptation set comprises means for retrieving data of the representation from the second adaptation set including at least the location of the switch point.

30. The device of claim 27, wherein the representation comprises a selected representation, further comprising:
means for determining bitrates for a plurality of representations in the second adaptation set using the manifest file;
means for determining a current amount of network bandwidth; and
means for selecting the selected representation from the plurality of the representations such that the bitrate for the selected representation does not exceed the current amount of network bandwidth.

31. A computer-readable storage medium having stored thereon instructions that, when executed, cause a processor to:
retrieve media data from a first adaptation set including media data of a first type;
present media data from the first adaptation set; and
in response to a request to switch to a second adaptation set including media data of the first type:
retrieve media data from the second adaptation set including a switch point of the second adaptation set; and
present media data from the second adaptation set after an actual playout time has met or exceeded a playout time for the switch point.

32. The computer-readable storage medium of claim 31, wherein the first type comprises at least one of audio data and subtitle data, wherein the first adaptation set includes a first plurality of representations including media data of the first type in a first language, and wherein the second adaptation set includes a second plurality of representations including media data of the first type in a second language different from the first language.

33. The computer-readable storage medium of claim 31, wherein the first type comprises video data, wherein the first adaptation set includes a first plurality of representations including video data for a first camera angle, and wherein the second adaptation set includes a second plurality of representations including video data for a second camera angle different from the first camera angle.

34. The computer-readable storage medium of claim 31, wherein at the time the request to switch to the second adaptation set is received, the playout time for the switch point is less than the actual playout time at the time the request to switch is received plus a threshold value.

35. The computer-readable storage medium of claim 31, wherein at the time the request to switch to the second adaptation set is received, the playout time for the switch point is greater than the actual playout time at the time the request to switch is received, further comprising instructions that cause the processor to retrieve data from the first adaptation set and the second adaptation set until playout time for retrieved media data from the second adaptation set has met or exceeded the actual playout time.

36. The computer-readable storage medium of claim 31, further comprising instructions that cause the processor to:
obtain a manifest file for the first adaptation set and the second adaptation set; and
determine a playout time for the switch point using data of the manifest file,
wherein the instructions that cause the processor to retrieve the media data comprise instructions that cause the processor to retrieve the media data based at least in part on a comparison of the playout time for the switch point to the actual playout time when the request to switch to the second adaptation set is received.

37. The computer-readable storage medium of claim 31, further comprising instructions that cause the processor to:
obtain a manifest file for the first adaptation set and the second adaptation set; and
determine a location of the switch point in a representation of the second adaptation set using data of the manifest file.

38. The computer-readable storage medium of claim 37, wherein the location is at least partially defined by a starting byte in a segment of the representation of the second adaptation set.

39. The computer-readable storage medium of claim 37, wherein the instructions that cause the processor to retrieve the media data from the second adaptation set comprise instructions that cause the processor to retrieve data of the representation from the second adaptation set including at least the location of the switch point.

40. The computer-readable storage medium of claim 37, wherein the representation comprises a selected representation, further comprising instructions that cause the processor to:
determine bitrates for a plurality of representations in the second adaptation set using the manifest file;
determine a current amount of network bandwidth; and
select the selected representation from the plurality of the representations such that the bitrate for the selected representation does not exceed the current amount of network bandwidth.
